(19) United States
(12) Patent Application Publication
(10) Pub. No.: US 2009/0295697 A1
(43) Pub. Date: Dec. 3, 2009

(54) Liquid crystal display panel

(75) Inventor: Xin Su, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/455,081

(22) Filed: May 28, 2009

(30) Foreign Application Priority Data
May 30, 2008 (TW) 97120034

(51) Int. Cl. G09G 3/36

(52) U.S. Cl. 345/92

(57) ABSTRACT

A liquid crystal display (LCD) panel includes scanning lines to receive scanning signals, data lines to receive data signals; and pixel pairs. Each pixel pair includes a first pixel and a second pixel. The first pixel includes a first thin film transistor (TFT), and the second pixel includes a second TFT. The first pixel and the second pixel of each pixel pair are arranged on two sides of the data line in each row, and connected to a single data line via the first TFT and the second TFT respectively. One of the two TFTs is a p-type TFT, and the other one is an n-type TFT.

### BACKGROUND

1. Technical Field

The present disclosure relates to liquid crystal displays (LCD), and particularly to an LCD panel having a p-type transistor and an n-type transistor in one pixel.

2. Description of Related Art

Because LCD panels have advantages of portability, low power consumption, and low radiation, they have been widely used in various portable information products such as notebooks, personal digital assistants (PDAs), video cameras, and the like.

Referring to FIG. 5, a commonly used LCD panel 1 includes a plurality of scanning lines 11, a plurality of data lines 12, a plurality of pixels 13, a plurality of thin film transistors (TFTs) 14, a scanning driver 16, and a data driver 15.

The data driver 15 provides data signals to the pixels 13 via the data lines 12 when the TFTs 14 are turned on. The scanning driver 16 provides scanning voltages to the scanning lines 11 to switch the TFTs 13 on or off. Each output terminal (not shown) of the data driver 15 can drive only one pixel 13. As the size of the LCD panel 1 increases, the number of required data drivers 15 increases, raising the cost of the LCD panel 1.

What is needed, therefore, is an LCD panel that can overcome the described limitations.

### BRIEF DESCRIPTION OF THE DRAWINGS

FIG. 1 is a circuit diagram of a first embodiment of an LCD panel according to the present disclosure, the LCD panel including m scanning lines.

FIG. 2 shows waveforms of scanning signals applied to the m scanning lines of FIG. 1.

FIG. 3 shows a second embodiment of an LCD panel according to the present disclosure.

FIG. 4 shows a third embodiment of an LCD panel according to the present disclosure.

FIG. 5 is a circuit diagram of a commonly used LCD panel.

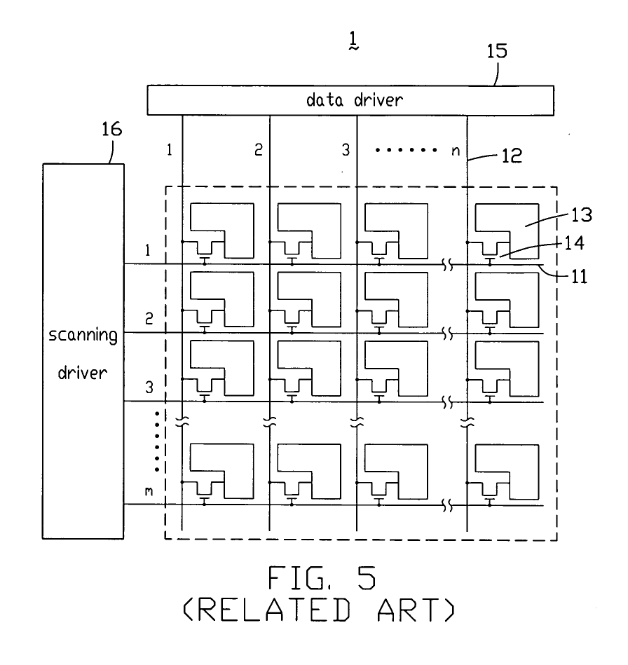

### DETAILED DESCRIPTION

Reference will now be made to the drawings to describe various embodiments of the present disclosure in detail.

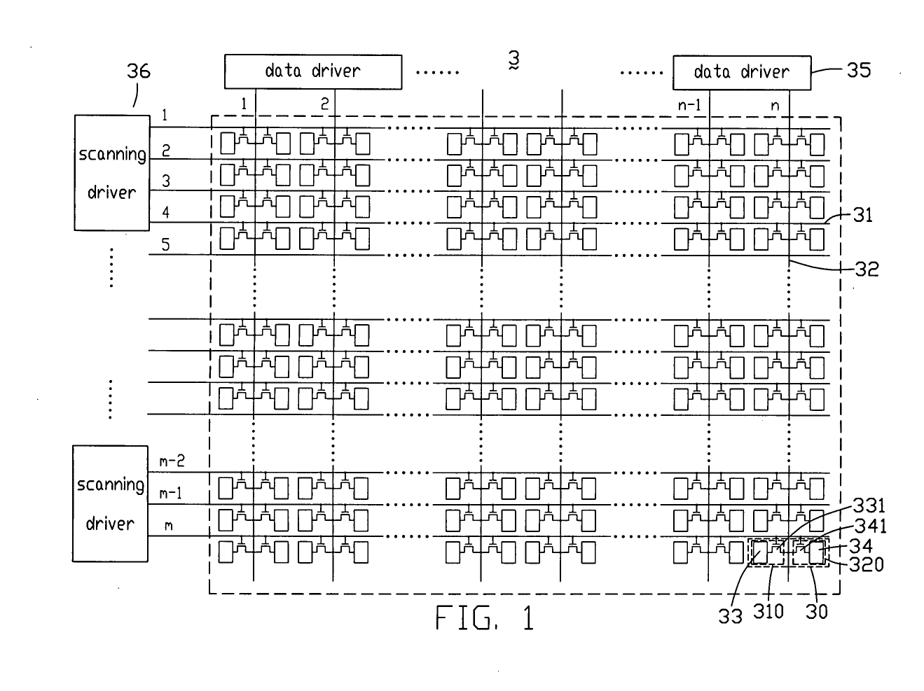

FIG. 1 is a circuit diagram of a first embodiment of an LCD panel according to the present disclosure. The LCD panel 3 includes m scanning lines 31, n data lines 32, a plurality of pixel pairs 30, a plurality of scanning drivers 36, and a plurality of data drivers 35. The scanning drivers 36 and the data drivers 35 drive the scanning lines 31 and the data lines 32, respectively.

Each pixel pair 30 includes a first pixel 310 and a second pixel 320. Each first pixel 310 includes a first pixel electrode 33 and a first TFT 331. Each second pixel 320 includes a second pixel electrode 34 and a second TFT 341. Gate electrodes of the first TFT 331 and the second TFT 341 of each pixel pair 30 are connected to a single scanning line 31. Source electrodes of the first TFT 331 and the second TFT 341 of each pixel pair 30 are connected to a single data line 32. Drain electrodes of the first TFT 331 and the second TFT 341 of each pixel pair 30 are connected to the first pixel electrode 33 and the second pixel electrode 34 respectively. The first TFT 331 is a p-type field-effect transistor (FET). The second TFT 341 is an n-type FET.

The first pixel 310 and the second pixel 320 of each pixel pair 30 are arranged on two sides of the corresponding data line 32, and arranged on one side of the corresponding scanning line 31. Furthermore, a pixel unit is defined by a minimum area formed by two adjacent data lines 32 and two adjacent scanning lines 31. That is, the pixel unit constitutes a first pixel 310 of one pixel pair 30 and a second pixel 320 of another adjacent pixel pair 30.

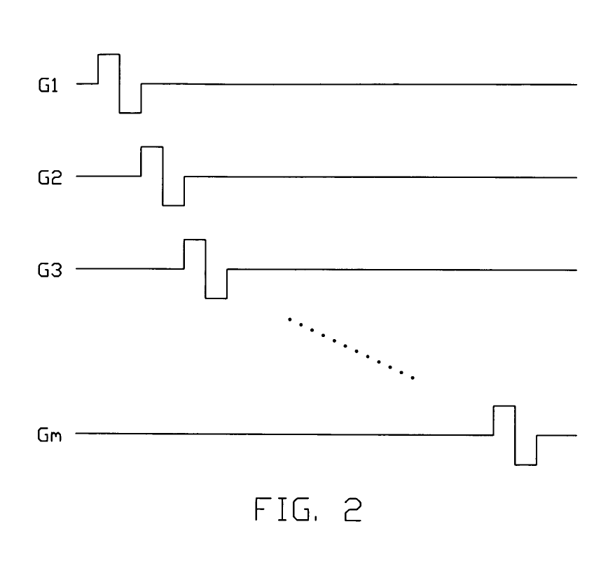

FIG. 2 shows waveforms of scanning signals G1-Gm of the m scanning lines. In a frame time, each scanning signal G1-Gm includes a positive pulse and a successive negative pulse. The scanning signals G1-Gm are applied to the scanning lines 31 sequentially.

In operation, when a first scanning line 31 is supplied with the positive pulse of the scanning signal G1, all the second TFTs 341 connected to the first scanning line 31 are turned on. Data signals are applied to all second pixel electrodes 34 via the data lines 32 and the corresponding second TFTs 341. Afterward, the first scanning line 31 is supplied with the negative pulse of the scanning signal GI, all the first TFTs 331 connected to the first scanning line 31 are turned on. Data signals are applied to all first pixel electrodes 33 via the data lines 32 and the corresponding first TFTs 331. Other scanning lines 31 from a second to the mth scanning lines 31 are driven in a similar principle to that of the first scanning line 31 described.

Unlike a conventional LCD panel, each pixel pair 30 of the LCD panel 3 includes the first pixel 310 and the second pixel 320. The first pixel electrode 33 of the first pixel 310 and the second pixel electrode 34 of the second pixel 320 are connected to the same data lines 32 and the same scanning lines 31 via the first p-type TFT 331 and the second n-type TFT 341 respectively. Each data line 32 can drive two pixels (the first pixel 310 and the second pixel 320). Thus, the number of data drivers 35 required for the LCD panel 3 decreases by half. Accordingly, a cost to manufacture the LCD panel 3 decreases as well. In addition, the aperture ratio of the LCD panel 3 can be increased.

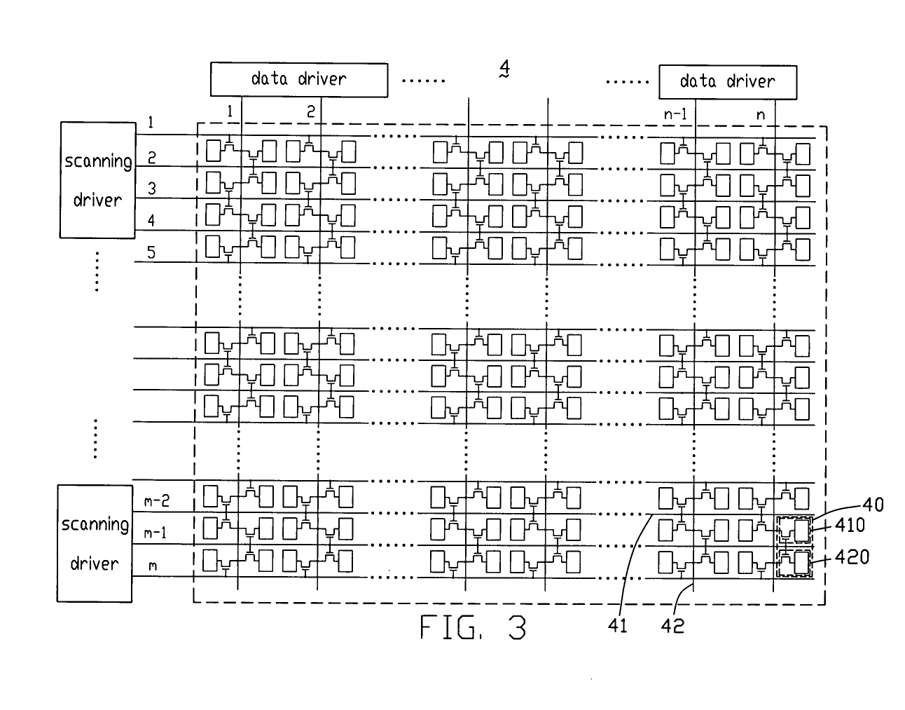

FIG. 3 shows a second embodiment of an LCD panel according to the present disclosure, differing from LCD panel 3 only in that each pixel pair 40 includes a first pixel 410 and a second pixel 420. The first pixel 410 and the second pixel 420 are arranged on two sides of a corresponding scanning line 41, and are arranged on one side of a corresponding data line 42. The first pixel 410 and the second pixel 420 are connected to a single scanning line 41, and are connected to a single data line 42. Each pixel pair 40 is arranged every two scanning lines 31 in each column along the data lines 42. That is, the pixel pairs 40 are arranged alternatively on two sides of the data lines 42. The LCD panel 4 has advantages similar to those of the LCD panel 3.

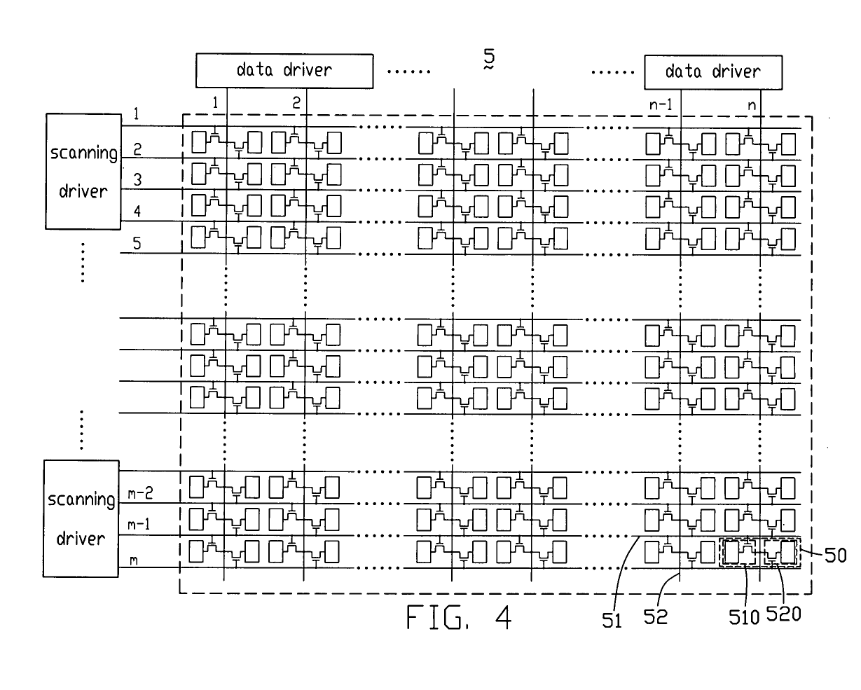

FIG. 4 shows a third embodiment of an LCD panel according to the present disclosure, differing from LCD panel 3 only in that each pixel pair 50 includes a first pixel 510 and a second pixel 520. The first pixel 510 and the second pixel 520 are connected to a single data line 42, and are connected to two adjacent scanning lines 41 respectively. That is, the first pixel 510 and the second pixel 520 are arranged alternatively on two sides of a corresponding data line 52. The LCD panel 5 has advantages similar to those of the LCD panel 3.

It is to be understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A liquid crystal display (LCD) panel, comprising:
a plurality of scanning lines to receive scanning signals;
a plurality of data lines to receive data signals; and
a plurality of pixel pairs, each pixel pair comprising a first pixel and a second pixel, the first pixel comprising a first thin film transistor (TFT), the second pixel comprising a second TFT, the first pixel and the second pixel of each pixel pair being arranged on two sides of the data line in each row, and connected to a single data line via the first TFT and the second TFT respectively, wherein one of the two TFTs is p-type TFT, and the other n-type.

2. The LCD panel of claim 1, wherein the first pixel and the second pixel of each pixel pair are driven by the same scanning line and the same data line.

3. The LCD panel of claim 1, wherein the first pixel and the second pixel of each pixel pair are driven by two adjacent scanning lines and the same data line.

4. The LCD panel of claim 3, wherein the first pixel and the second pixel of each pixel pair are arranged alternatively on two sides of the data line.

5. The LCD panel of claim 1, further comprising a plurality of scanning drivers to provide scanning signals to the scanning lines and a plurality of data drivers to provide data signals to the data lines.

6. The LCD panel of claim 1, the first pixel further comprising a first pixel electrode, and the second pixel further comprising a second pixel electrode, the first pixel electrode and the second pixel electrode being connected to the data lines and the scanning lines via the first TFT and the second TFT respectively.

7. The LCD panel of claim 1, wherein the scanning signal of each scanning line is a pulse comprising a positive pulse and a successive negative pulse.

8. A liquid crystal display (LCD) panel, comprising:
a plurality of scanning lines to receive scanning signals;
a plurality of data lines to receive data signals; and
a plurality of pixel pairs, each pixel pair comprising a first pixel and a second pixel, the first pixel comprising a first thin film transistor (TFT), the second pixel comprising a second TFT, the first pixel and the second pixel of each pixel pair being arranged alternatively on two sides of the data line in each column, and connected to a single data line and the same scanning line via the first TFT and the second TFT respectively, wherein one of the two TFTs is p-type TFT, and the other n-type.

9. The LCD panel of claim 8, wherein the pixel pairs are arranged every two scanning lines in each column direction.

10. The LCD panel of claim 8, further comprising a plurality of scanning drivers to provide scanning signals to the scanning lines and a plurality of data drivers to provide data signals to the data lines.

11. The LCD panel of claim 9, the first pixel further comprising a first pixel electrode, and the second pixel further comprising a second pixel electrode, the first pixel electrode and the second pixel electrode being connected to the data lines and the scanning lines via the first TFT and the second TFT respectively.

12. The LCD panel of claim 8, wherein the scanning signal of each scanning line is a pulse comprising a positive pulse and a successive negative pulse.

13. A liquid crystal display (LCD) panel, comprising:
a plurality of scanning drivers to output scanning signals;
a plurality of data drivers to output data signals;
a plurality of scanning lines to receive the scanning signals;
a plurality of data lines to receive the data signals; and
a plurality of pixel pairs, each pixel pair comprising a first pixel and a second pixel, the first pixel comprising a first thin film transistor (TFT), the second pixel comprising a second TFT, the first pixel and the second pixel of each pixel pair being connected to a single data line and the same scanning line via the first TFT and the second TFT respectively, wherein one of the two TFTs is p-type TFT, and the other n-type.

14. The LCD panel of claim 13, the first pixel further comprising a first pixel electrode, and the second pixel further comprising a second pixel electrode, the first pixel electrode and the second pixel electrode being connected to the data lines and the scanning lines via the first TFT and the second TFT respectively.

15. The LCD panel of claim 13, wherein the scanning signal of each scanning line is a pulse comprising a positive pulse and a successive negative pulse.
